(19) United States
(12) Patent Application Publication
(10) Pub. No.: US 2026/0322004 A1
(43) Pub. Date: Oct. 15, 2026

(54) CONNECTOR

(71) Applicant: SUMITOMO WIRING SYSTEMS, LTD., Mie (JP)

(72) Inventors: Takuya OSHITA, Mie (JP); Yuki SUGIMOTO, Mie (JP); Masaya INOUE, Mie (JP)

(21) Appl. No.: 19/467,562

(22) Filed: Feb. 2, 2026

(30) Foreign Application Priority Data
Feb. 6, 2025 (JP) 2025-018290

(51) Int. Cl. H01R 12/70; H01R 12/72

(52) U.S. Cl. CPC H01R 12/7011; H01R 12/722

(57) ABSTRACT

A housing includes a tubular receptacle having a fitting space open forward and a holding portion integrally provided to the receptacle. The terminal includes a mating connecting portion projecting into the fitting space through a back wall of the receptacle and a board connecting portion to be connected to a circuit board having a thickness in a height direction intersecting a front-rear direction. The holding portion is held on the circuit board. At least a part of the holding portion is provided at a position overlapping a height range of the fitting space in the height direction.

### CROSS-REFERENCE TO RELATED APPLICATIONS

This application is based on and claims priority from Japanese Patent Application No. 2025-018290, filed on February 6, 2025, with the Japan Patent Office, the disclosure of which is incorporated herein in its entirety by reference.

### TECHNICAL FIELD

The present invention relates to a connector.

### BACKGROUND

Japanese Patent Laid-open Publication No. H05-062742 discloses a board connection connector (connector) to be assembled with a board (circuit board). The connector is provided with a terminal to be connected to the circuit board and a housing for mounting the terminal. A housing is provided with a fixing means for holding the connector on the board. The fixing means includes a hook-shaped plate portion projecting from the lower surface of the housing and extending rearward while facing the lower surface. The circuit board is sandwiched between the lower surface of the housing and the plate portion. In this way, the connector is held on the circuit board.

A board connector disclosed in Japanese Patent Laid-open Publication No. 2000-348799 is provided with a housing including a fitting hole open upward and a male terminal to be mounted into the housing. The male terminal includes a pull-out end part extending in a vertical direction and projecting into the fitting hole. The pull-out end part is pulled out to the outside of the housing.

A board connector disclosed in Japanese Patent Laid-open Publication No. 2004-214093 is provided with a lead terminal to be connected to a printed board (circuit board) and a housing for mounting the lead terminal. The lower surface of the housing is provided with a hook portion for sandwiching the printed board between the lower surface and the hook portion.

### SUMMARY

In any of Japanese Patent Laid-open Publication No. H05-062742, Japanese Patent Laid-open Publication No. 2000-348799 and Japanese Patent Laid-open Publication No. 2004-214093, the connector tends to be enlarged in a height direction, which is a thickness direction of the circuit board. Particularly, the connector of Japanese Patent Laid-open Publication No. H05-062742, in which the hook-shaped plate portion projects from the lower surface of the housing, and the connector of Japanese Patent Laid-open Publication No. 2004-214093, in which the hook portion projects from the lower surface of the housing, are enlarged due to a structure for holding the housing on the circuit board.

Accordingly, the present disclosure aims to provide a connector capable of avoiding enlargement in a height direction.

The present disclosure is directed to a connector with a housing and a terminal, the housing including a tubular receptacle having a fitting space open forward and a holding portion integrally provided to the receptacle, the terminal including a mating connecting portion projecting into the fitting space through a back wall of the receptacle and a board connecting portion to be connected to a circuit board having a thickness in a height direction intersecting a front-rear direction, the holding portion being held on the

circuit board, and at least a part of the holding portion being provided at a position overlapping a height range of the fitting space in the height direction.

According to the present disclosure, it is possible to provide a connector capable of avoiding enlargement in a height direction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a front view showing a state where a connector of one embodiment is assembled with a circuit board.

FIG. 2 is a plan view in section cut at a height position corresponding to the circuit board showing the state where the connector of the embodiment is assembled with the circuit board.

FIG. 3 is a side view showing the state where the connector of the embodiment is assembled with the circuit board.

FIG. 4 is an exploded perspective view of a housing and terminals in the connector of the embodiment when viewed from behind.

FIG. 5 is a perspective view of the connector of the embodiment when viewed from front.

FIG. 6 is a bottom view of the connector of the embodiment.

FIG. 7 is a plan view of the circuit board, with which the connector of the embodiment is assembled.

FIG. 8 is a side view showing a state where a guiding surface of a resilient lock portion is in contact with the circuit board in the process of assembling the connector of the embodiment with the circuit board.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Descriptions of Embodiments of Present Disclosure

First, embodiments of the present disclosure are listed and described.

(1) The connector of the present disclosure is provided with a housing and a terminal, the housing including a tubular receptacle having a fitting space open forward and a holding portion integrally provided to the receptacle, the terminal including a mating connecting portion projecting into the fitting space through a back wall of the receptacle and a board connecting portion to be connected to a circuit board having a thickness in a height direction intersecting a front-rear direction, the holding portion being held on the circuit board, and at least a part of the holding portion being provided at a position overlapping a height range of the fitting space in the height direction.

Since the receptacle has the fitting space open forward and at least a part of the holding portion is provided at the position overlapping the height range of the fitting space in the height direction, the enlargement of the connector in the height direction due to the presence of the holding portion can be avoided.

(2) Preferably, in the connector of (1) described above, the receptacle includes a pair of side walls facing each other in a width direction intersecting the front-rear direction and the height direction, and the holding portions are bent inward in the width direction in the pair of side walls and shaped to sandwich the circuit board by upper end parts and lower end parts of bent parts.

If the holding portion is shaped to be bent inward in the width direction in each side wall, the connector is not enlarged in the width direction and the entire connector can be reduced in size.

(3) Preferably, in the connector of (2) described above, at least one of the upper end part and the lower end part of the holding portion is a resilient lock portion resiliently deformable in the height direction and includes a locking projection lockable to the circuit board.

Since the holding portions are held on the circuit board after the resilient lock portions are resiliently deformed, the connector is easily assembled with the circuit board.

(4) Preferably, in the connector of (3) described above, the holding portion has a holding space open rearward between the upper end part and the lower end part, the resilient lock portion is the lower end part of the holding portion and is cantilevered rearward, and a rear end part of the resilient lock portion is provided with a guiding surface inclined in a direction to expand the holding space toward rear.

The guiding surfaces slide in contact with the circuit board, whereby the resilient lock portions can be smoothly resiliently deformed and the connector is more easily assembled with the circuit board.

### Details of Embodiment of Present Disclosure

A specific example of a connector of the present disclosure is described below with reference to the drawings. Note that the present invention is not limited to these illustrations, but is represented by claims and intended to include all changes in the scope of claims and in the meaning and scope of equivalents.

### Embodiment

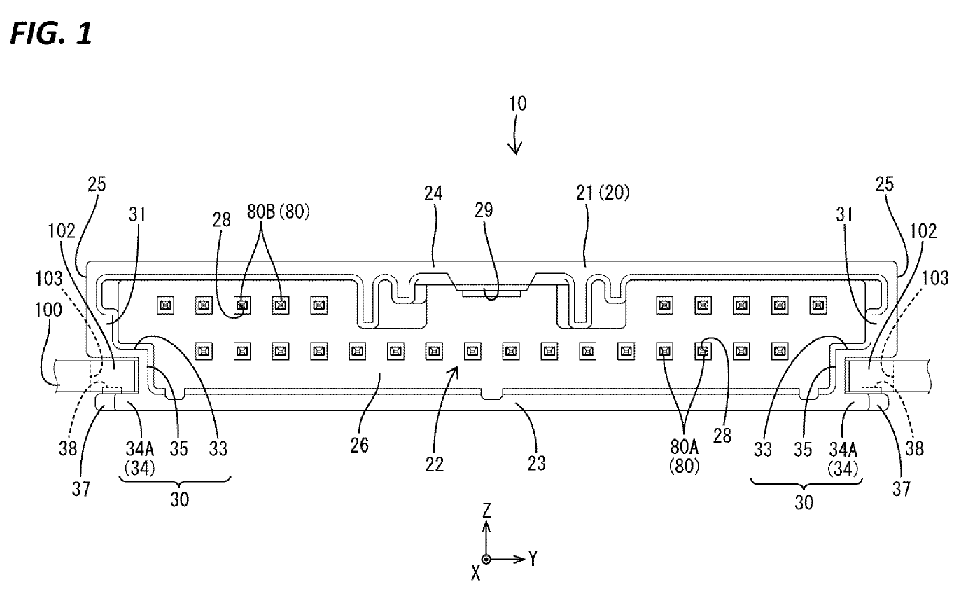

A connector 10 of one embodiment is, as shown in FIG. 1, provided with terminals 80 and a housing 20. The terminals 80 are mounted into the housing 20. The housing 20 is connected to an unillustrated mating connector. The connector 10 is assembled with a circuit board 100. The housing 20 is held on the circuit board 100. The terminals 80 are connected to the circuit board 100. Note that, in the following description, a connection direction of the connector 10 to the mating connector is referred to as a forward direction concerning a front-rear direction. A vertical direction and a lateral direction are based on a vertical direction and a lateral direction of FIG. 1. The vertical direction is equivalent to a thickness direction of the circuit board 100. X, Y and Z in FIG. 1 respectively denote a front side, a right side and an upper side. The vertical direction may also be called a height direction. The lateral direction may also be called a width direction. These direction references are for convenience and do not necessarily coincide with direction references in a state where the connector 10 is installed in an unillustrated vehicle or the like.

### Terminals 80

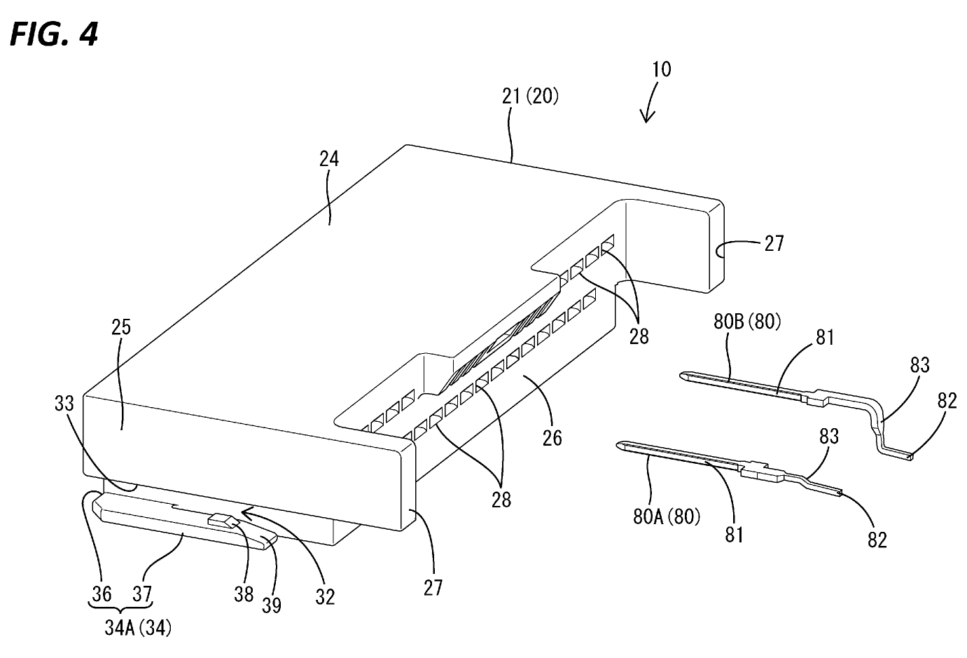

The terminal 80 is made of electrically conductive metal and pin-shaped or tab-shaped as shown in FIG. 4. The terminal 80 includes a mating connecting portion 81 extending in the front-rear direction, a board connecting portion 82 located behind and below the mating connecting portion 81 and extending in the front-rear direction and an intermediate extending portion 83 extending from the front end of the board connecting portion 82 to the rear end of the mating connecting portion 81. The mating connecting portion 81 is mounted into the housing 20 through a later-described back wall 26 of the housing 20. The mating connecting portion 81 projects into a later-described receptacle of the housing 20 and is connected to an unillustrated mating terminal at the time of connection to the mating connector. The board connecting portion 82 is arranged along a surface of the circuit board 100, and soldered and connected to an unillustrated electrically conductive portion of the circuit board 100.

A plurality of the terminals 80 are mounted into the housing 20. The plurality of terminals 80 are composed of two types of first terminals 80A including the mating connecting portions 81 to be mounted in a lower stage of the housing 20 and second terminals 80B including the mating connecting portions 81 to be mounted in an upper stage of the housing 20. A length of the intermediate extending portion 83 of the first terminal 80A is shorter than that of the intermediate extending portion 83 of the second terminal 80B. Here, the length of the intermediate extending portion 83 of the first terminal 80A is shorter than a height difference between the lower surface of the mating connecting portion 81 and the upper surface of the board connecting portion 82.

### Housing 20

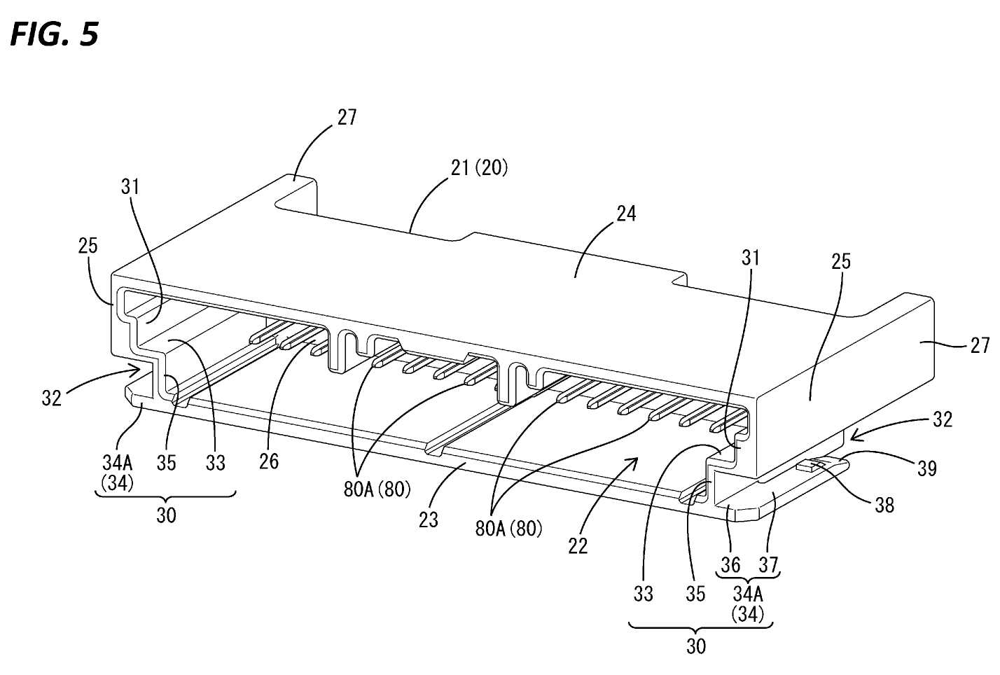

The housing 20 is made of synthetic resin and includes the tubular receptacle 21. As shown in FIGS. 1 and 5, the receptacle 21 is in the form of a flat rectangular tube longer in the lateral direction than in the vertical direction. The receptacle 21 includes a fitting space 22 open forward. The unillustrated mating connector is fit into the fitting space 22 of the receptacle 21.

The receptacle 21 includes a bottom wall 23, an upper wall 24, a pair of left and right side walls 25 and a back wall 26. The bottom wall 23 and the upper wall 24 are in the form of flat plates along the front-rear direction and the lateral direction. The upper wall 24 is located above the bottom wall 23. Each side wall 25 is in the form of a vertical wall along the front-rear direction and the vertical direction. The respective side walls 25 are facing each other in the lateral direction. The respective side walls 25 are coupled to left and right outer ends of the bottom wall 23 and the upper wall 24.

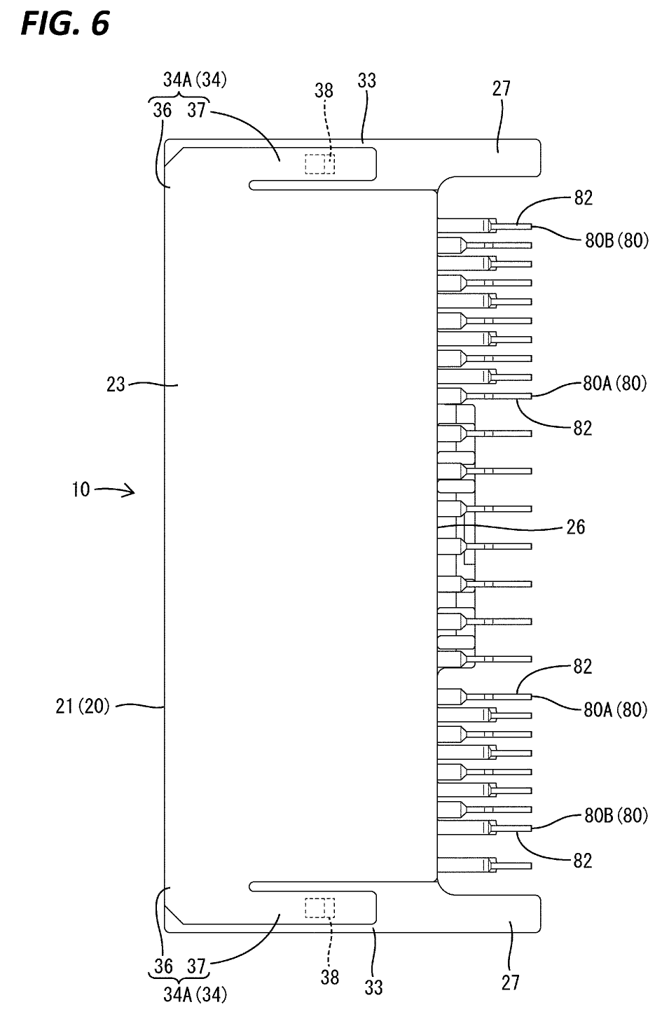

The back wall 26 is in the form of a vertical wall along the lateral direction and the vertical direction. The back wall 26 is coupled to the upper end of each of the bottom wall 23 and the upper wall 24. The left and right outer ends of the back wall 26 are respectively coupled to the respective side walls 25. As shown in FIGS. 4 and 5, the respective side walls 25 include a pair of left and right protecting portions 27 extending further rearward than the back wall 26. As shown in FIG. 6, the respective protecting portions 27 can cover the board connecting portions 82 of the respective terminals 80 from lateral sides. As shown in FIG. 1, an opening height in the vertical direction of the fitting space 22 is defined between the bottom wall 23 and the upper wall 24. An opening width in the lateral direction of the fitting space 22 is defined between the respective side walls 25.

As shown in FIG. 4, the back wall 26 is provided with a plurality of mounting holes 28. A plurality of the mounting holes 28 are arranged side by side in the lateral direction in two stages in the vertical direction. The mating connecting portion 81 of each terminal 80 is inserted and mounted into each mounting hole 28 from behind. The intermediate extending portion 83 and the board connecting portion 82 of each terminal 80 are pulled out rearward from each mounting hole 28 and arranged to be exposed to the outside of the housing 20. As shown in FIG. 1, a lock portion 29 is provided in a lateral central part of the upper wall 24. The lock portion 29 projects into the fitting space 22 and locks the mating connector fit in the fitting space 22.

As shown in FIG. 1, each side wall 25 is integrally provided with a holding portion 30. A pair of the holding portions 30 are provided at positions near the lower ends of the respective side walls 25 and over the entire lengths in the front-rear direction of the respective side walls 25. The housing 20 is held on the circuit board 100 in a separation prevented state by the holding portions 30.

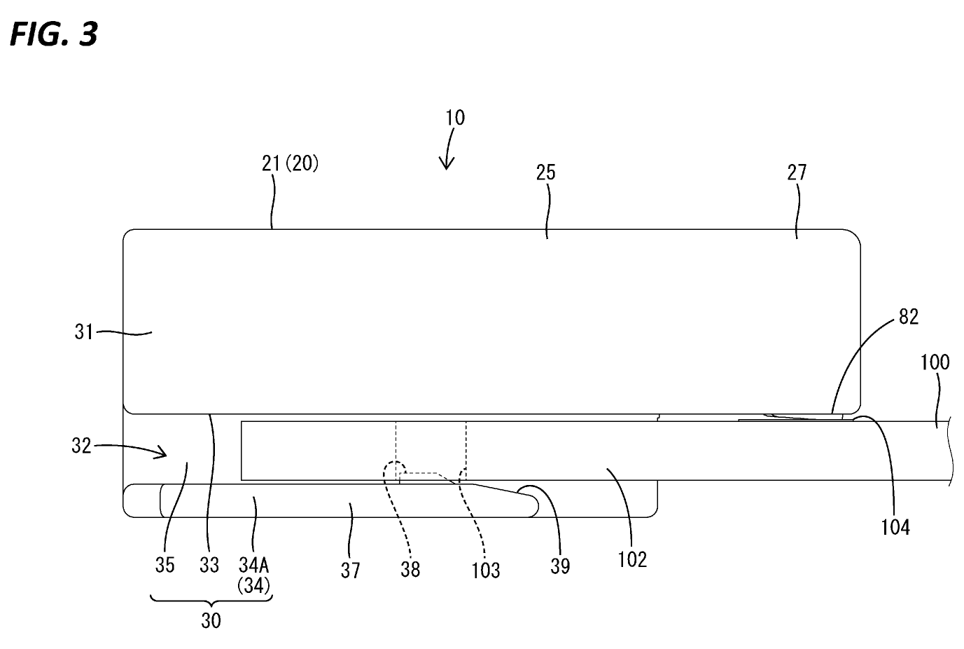

The holding portion 30 has a recess shape bent laterally inward with respect to an upper part 31 above the holding portion 30 in the side wall 25. As shown in FIG. 5, the holding portion 30 has a holding space 32 open laterally outward. The holding space 32 is also open rearward through a space below the protecting portion 27. As shown in FIG. 3, a later-described edge part 102 of the circuit board 100 is arranged to be sandwiched in the vertical direction in the holding space 32 of the holding portion 30. As shown in FIGS. 1 and 3, the upper, lower and left/right inner end of the holding space 32 are respectively defined by an upper end part 33, a lower end part 34 and an inner end part 35. The upper, lower and inner end parts 33, 34 and 35 constitute a recess-shaped part of the holding portion 30.

The upper end part 33 is in the form of a plate extending along the lateral direction and the front-rear direction. As shown in FIG. 1, the upper end part 33 is coupled at a right angle to the upper part 31 of the side wall 25. The upper surface of the upper end part 33 is facing the fitting space 22. As shown in FIG. 3, the lower surface of the upper end part 33 is facing the holding space 32. The lower surface of the upper end part 33 is continuous with the lower surface of the protecting portion 27 without any step in the front-rear direction. The upper end part 33 is coupled to the upper part 31 of the side wall 25 over the entire length in the front-rear direction of the fitting space 22 and is rigid not to be resiliently deformed.

As shown in FIG. 1, the inner end part 35 is in the form of a plate extending along the vertical direction and the front-rear direction. The upper end of the inner end part 35 is coupled to the upper end part 33 over the entire length in the front-rear direction of the fitting space 22. The lower end of the inner end part 35 is continuous with the lower surface of the bottom wall 23 without any step in the lateral direction. A part near the lower end of the inner end part 35 is coupled to the bottom wall 23. The inner end part 35 is also rigid not to be resiliently deformed. The left/right inner surface of the inner end part 35 is facing the fitting space 22. The left/right outer surface of the inner end part 35 is facing the holding space 32.

As shown in FIGS. 4 and 5, the lower end part 34 is configured as a resilient lock portion 34A. The resilient lock portion 34A includes a supporting portion 36 protruding laterally outward from a part near the front end and the lower end of the inner end part 35 and a lock body portion 37 coupled to the left/right outer end of the supporting portion 36 and cantilevered rearward from the coupled part. The supporting portion 36 and the lock body portion 37 are in the form of plates. The upper and lower surfaces of each of the supporting portion 36 and the lock body portion 27 are flat surfaces continuous without any step in the front-rear direction and the lateral direction. The upper surface of each of the supporting portion 36 and the lock body portion 37 is facing the holding space 32. The rear end of the lock body portion 37 is arranged to be retracted forward from the rear end of the back wall 26.

As shown in FIG. 5, the front surface of the supporting portion 36 is continuous with the front surface of the inner end part 35 without any step in the lateral direction. The lock body portion 37 is resiliently deformable in the vertical direction with a coupled part to the supporting portion 36 as a fulcrum. The lock body portion 37 is resiliently deformed downward away from the upper end part 33, whereby the holding space 32 is expanded in the vertical direction. As shown in FIG. 6, the left/right outer end of the lock body portion 37 is arranged along the front-rear direction. As shown in FIG. 1, the left/right outer end of the lock body portion 37 is arranged to be retracted laterally inward with respect to the left/right outer end of the upper part 31 of the side wall 25.

As shown in FIGS. 4 and 5, a locking projection 38 is provided on the upper surface of the lock body portion 37. The locking projection 38 is in the form of a flat projection and projects into the holding space 32 from a lateral center near the rear end (tip, free end) of the lock body portion 37. The front surface of the locking projection 38 is arranged along the lateral direction and the vertical direction. The rear surface of the locking projection 38 is inclined rearward toward an upper side. A guiding surface 39 is provided on a part near the rear end, out of the upper surface of the lock body portion 37. The guiding surface 39 is inclined downward to gradually expand the holding space 32 from a position behind the locking projection 38 on the upper surface of the lock body portion 37 to the rear end of the lock body portion 37. The guiding surface 39 is provided over the entire width in the lateral direction of the upper surface of the lock body portion 37. A part below the guiding surface 39, out of the lower surface of the lock body portion 37, is flatly arranged along the front-rear direction.

### Circuit Board 100

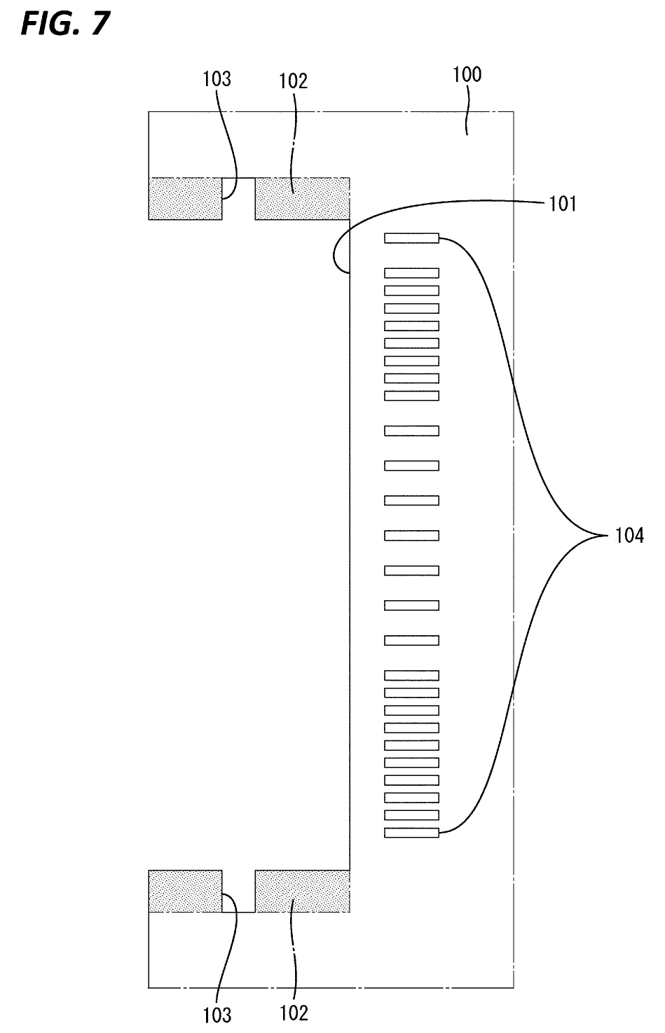

The circuit board 100 is a rigid printed circuit board. As shown in FIG. 7, the circuit board 100 has a front end along the lateral direction, and a concave recess 101 is provided in this front end. The recess 101 has a rectangular shape in a plan view and is open forward of the circuit board 100 and in the vertical direction. An opening width in the lateral direction of the recess 101 corresponds to a separation distance between the left and right outer surfaces of the inner end parts 35 of the holding portions 30 paired in the lateral direction. In the circuit board 100, the edge parts 102 along left and right inner ends (end edges facing each other in the lateral direction) of the recess 101 are parts for contacting the holding portions 30 of the housing 20. The edge parts 102 are paired at the left and right inner ends of the recess 101 and provided to extend in the front-rear direction while having a constant width in the lateral direction.

The edge parts 102 of the recess 101 are cut to provide locking recesses 103. The locking recesses 103 have a rectangular shape in a plan view and are paired at the left and right inner ends of the recess 101. The locking projection 38 is lockably inserted into the locking recess 103. A plurality of solder paste portions 104 arranged side by side in the lateral direction and the front-rear direction behind the recess 101 are provided on a surface (upper surface) of the circuit board 100. Cream solder for soldering the board connecting portion 82 of each terminal 80 is applied to each solder paste portion 104.

### Functions of Connector 10

Prior to the assembly the connector 10 with the circuit board 100, the respective terminals 80 are mounted into the housing 20. If the respective terminals 80 are mounted in the housing 20, the board connecting portions 82 of the respective terminals 80 are arranged at a height overlapping the holding portions 30 in the height direction.

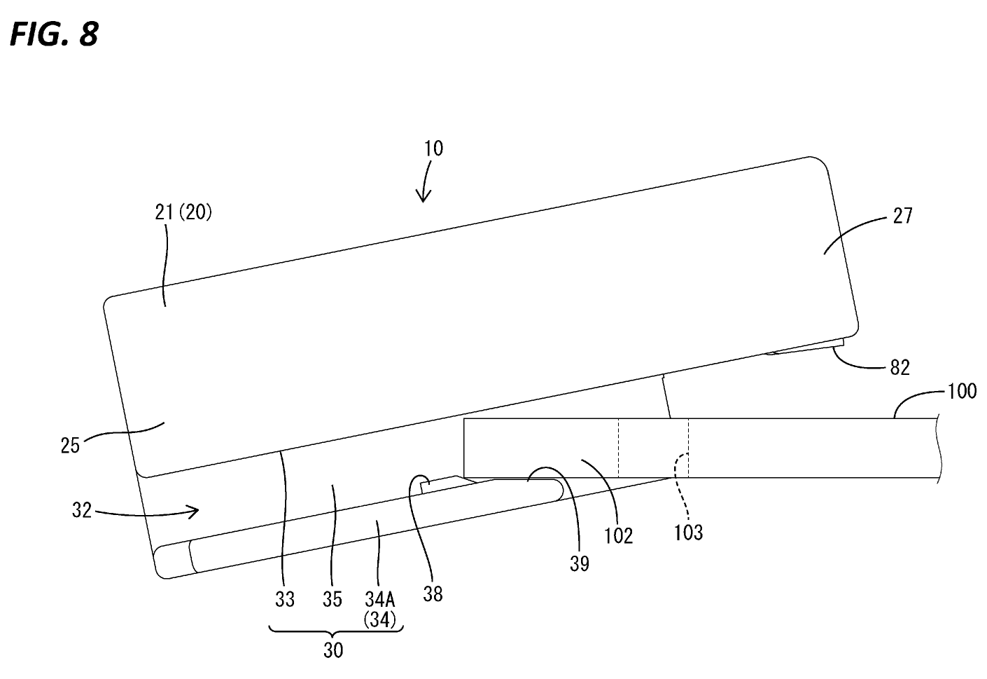

Subsequently, as shown in FIG. 8, the housing 20 is arranged in a posture inclined upward toward the rear with respect to the circuit board 100. In that state, the housing 20 is assembled with the circuit board 100 from front. Since the housing 20 is in the posture inclined upward toward the rear, the board connecting portions 82 of the respective terminals 80 are separated from the surface of the circuit board 100 and the interference thereof with the circuit board 100 can be avoided. If the housing 20 in the posture inclined upward toward the rear is moved rearward, the edge parts 102 of the circuit board 100 are inserted into the holding spaces 32 of the holding portions 30 from behind. At this time, the edge parts 102 of the circuit board 100 slide in contact with the guiding surfaces 39 of the resilient lock portions 34A and an inserting operation into the holding spaces 32 is guided. The edge parts 102 of the circuit board 100 contact the front surfaces of the locking projections 38 of the resilient lock portions 34A and the like, whereby the resilient lock portions 34A are resiliently deformed downward to expand the holding spaces 32 and further insertion of the edge parts 102 into the holding spaces 32 is allowed. In the process of continuing the insertion of the edge parts 102 into the holding spaces 32 and moving the edge parts 102 forward with respect to the holding spaces 32, the housing 20 receives resilient reaction forces of the resilient lock portions 34A and is gradually corrected from the posture inclined upward toward the rear to a horizontal posture.

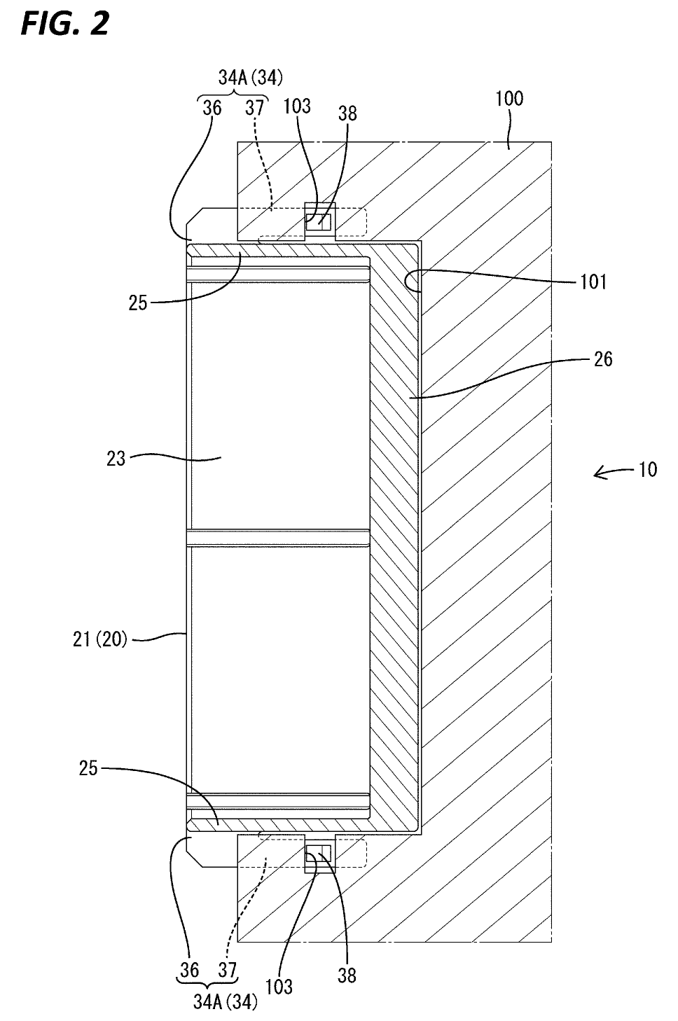

As shown in FIGS. 1 to 3, when the housing 20 reaches a proper assembly position with respect to the circuit board 100, the housing 20 is arranged in the horizontal posture, the resilient lock portions 34A resiliently return and the locking projections 38 are fit into the locking recesses 103. The rear surfaces of the locking projections 38 face and contact the inner front surfaces (surface facing rearward) of the locking recesses 103, whereby the housing 20 is prevented from being separated forward from the circuit board 100. Further, as shown in FIG. 2, the rear surface of the back wall 26 faces and contacts the inner back end edge (end edge facing forward) of the recess 101, whereby the housing 20 is prevented from moving any further rearward with respect to the circuit board 100. Note that a part near the front end of the housing 20 is arranged to project forward from the front end of the circuit board 100.

As shown in FIG. 3, the lower surface of the upper end part 33 of the holding portion 30 and the lower surface of the protecting portion 27 are arranged along the surface of the circuit board 100. The upper surface of the lock body portion 37 of the resilient lock portion 34A, which is the lower end part 34 of the holding portion 30, is arranged along the underside (lower surface) of the circuit board 100. In this way, the edge parts 102 are arranged to be sandwiched between the upper end parts 33 and the lower end parts 34 of the holding portions 30, whereby the housing 20 is prevented from being separated upward and downward from the circuit board 100.

As shown in FIG. 1, the left and right inner ends of the edge parts 102 are arranged near the left and right outer surfaces of the inner end parts 35 of the respective holding portions 30 to be confined within a width range in the lateral direction of the fitting space 22. The edge parts 102 are arranged to be confined within a height range in the vertical direction of the fitting space 22. The housing 20 is arranged with good space efficiency without taking up a large space in the lateral direction and the vertical direction with respect to the circuit board 100. Thereafter, the connector 10 is reflow-processed and the board connecting portion 82 of each terminal 80 is soldered and fixed to each solder paste portion 104 of the circuit board 100 (see FIG. 3).

As described above, the connector 10 of this embodiment is provided with the housing 20 and the terminals 80. The housing 20 includes the tubular receptacle 21 having the fitting space 22 open forward and the holding portions 30 integrally provided to the receptacle 21. The terminal 80 includes the mating connecting portion 81 projecting into the fitting space 22 through the back wall 26 of the receptacle 21 and the board connecting portion 82 to be connected to the circuit board 100. The holding portion 30 is held on the circuit board 100 having a thickness in the height direction intersecting the front-rear direction. Parts (upper end part 33 and inner end part 35) of the holding portion 30 are provided at positions overlapping a height range of the fitting space 22 in the height direction.

Since the receptacle 21 has the fitting space 22 open forward and the holding portions 30 include parts overlapping the height range of the fitting space 22 in the height direction, the height of the connector 10 can be suppressed as compared to the case where the holding portions 30 project downward from the receptacle 21. Further, the number of components can be reduced as compared to the case where fixing brackets to be soldered and fixed to the circuit board 100 are mounted on the housing 20.

Further, the receptacle 21 includes the pair of side walls 25 facing each other in the width direction intersecting the front-rear direction and the height direction. The holding portion 30 is bent inward in the width direction in each side wall 25, and shaped to sandwich the circuit board 100 by the upper end part 33 and the lower end part 34 of that bent part.

If the holding portion 30 is shaped to be located inward in the width direction in each side wall 25, the connector 10 is not enlarged in the width direction and the entire connector 10 can be reduced in size.

Further, the lower end part 34 of the holding portion 30 is the resilient lock portion 34A resiliently deformable in the height direction and includes the locking projection 38 lockable to the circuit board 100.

According to this, since the holding portions 30 are held on the circuit board 100 after the resilient lock portions 34A are resiliently deformed, the connector 10 is easily assembled with the circuit board 100.

Furthermore, the holding portion 30 has the holding space 32 open rearward between the upper end part 33 and the lower end part 34. The resilient lock portion 34A, which is the lower end part 34, is cantilevered rearward. The rear end part of the resilient lock portion 34A is provided with the guiding surface 39 inclined in a direction to expand the holding space 32 toward the rear.

According to this, the guiding surface 39 can slide in contact with the circuit board 100. In that state, the resilient lock portion 34A is resiliently deformable, wherefore the connector 10 is more easily assembled with the circuit board 100.

### Other Embodiments of Disclosure

The embodiment disclosed this time should be considered illustrative in all aspects, rather than restrictive.

In the case of the above embodiment, the lower end part of the holding portion is configured as the resiliently deformable resilient lock portion. In contrast, according to another embodiment, an upper end part of a holding portion may be configured as a resiliently deformable resilient lock portion or both upper and lower end parts of the holding portion may be configured as resilient lock portions. Further, according to another embodiment, both upper and lower end parts of a holding portion may be rigid not to be resiliently deformed without being configured as resilient lock portions.

In the case of the above embodiment, the upper and inner end parts of the holding portion are arranged to be confined within the height range of the fitting space in the height direction. In contrast, according to another embodiment, an entire holding portion including a lower end part may be arranged to be confined within a height range of a fitting space. Further, according to another embodiment, a part of a holding portion may be arranged outside a height range of a fitting space.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising a housing and a terminal,
the housing including a tubular receptacle having a fitting space open forward and a holding portion integrally provided to the receptacle,
the terminal including a mating connecting portion projecting into the fitting space through a back wall of the receptacle and a board connecting portion to be connected to a circuit board having a thickness in a height direction intersecting a front-rear direction,
the holding portion being held on the circuit board, and
at least a part of the holding portion being provided at a position overlapping a height range of the fitting space in the height direction.

2. The connector of claim 1, wherein:
the receptacle includes a pair of side walls facing each other in a width direction intersecting the front-rear direction and the height direction, and
the holding portions are bent inward in the width direction in the pair of side walls and shaped to sandwich the circuit board by upper end parts and lower end parts of bent parts.

3. The connector of claim 2, wherein at least one of the upper end part and the lower end part of the holding portion is a resilient lock portion resiliently deformable in the height direction and includes a locking projection lockable to the circuit board.

4. The connector of claim 3, wherein:
the holding portion has a holding space open rearward between the upper end part and the lower end part,
the resilient lock portion is the lower end part of the holding portion and is cantilevered rearward, and
a rear end part of the resilient lock portion is provided with a guiding surface inclined in a direction to expand the holding space toward rear.
